(19) United States
(12) Patent Application Publication
(10) Pub. No.: US 2010/0196217 A1
(43) Pub. Date: Aug. 5, 2010

(54) APPLICATION OF BASIC EXCHANGE OS MATERIALS FOR LOWER TEMPERATURE CATALYTIC OXIDATION OF PARTICULATES

(76) Inventors: Barry W.L. Southward, Frankfurt (DE); Curt Ellis, Broken Arrow, OK (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/363,329

(22) Filed: Jan. 30, 2009

(51) Int. Cl. B01D 53/34; B01J 23/00

(52) U.S. Cl. 422/168; 502/304

(57) ABSTRACT

Catalysts for the direct catalytic oxidation of diesel particulate matter are disclosed. The catalysts relate to OIC/OS materials having a stable cubic crystal structure, and most especially to promoted OIC/OS wherein the promotion is achieved by the post-synthetic introduction of non-precious metals via a basic (alkaline) exchange process.

### INTRODUCTION AND BACKGROUND

The introduction of increasingly stringent emission regulations has led to the introduction of catalytic technologies to address the emissions, both gaseous and solid, emitted as by-products of the internal combustion engine. For the compression ignition/diesel engine these devices include the Diesel Oxidation Catalysts (DOC), Diesel NOx Trap (DNT) and Selective Catalytic Reduction catalysts (SCR) to address CO, HC (DOC) and nitrogen oxides (NOx) emissions while the Catalysed Diesel Particulate Filter (CDPF) has been applied to address the problem of ‘soot’ emissions. These devices typically comprise an inert porous ceramic (e.g. cordierite or Silicon Carbide for CDPF) monolith substrate which is wash-coated with the active formulation. The wash-coat formulation itself will typically be a heterogeneous-phase catalyst containing particles of highly active precious group metal (PGM) which are dispersed and stabilised on a refractory oxide support or supports; e.g. alumina, solid solutions/mixed oxide. In the case of the CDPF soot interception device the washcoat is deposited upon a ‘wall-flow’ monolith which acts to sieve out the bulk of the soot from the exhaust flow.

The solid solution materials referred to above are typically based upon mixed oxides of CeO₂/ZrO₂ are also commonly referred to as Oxygen Storage (OS) materials and are solid electrolytes known for their oxygen ion conductivity characteristic. In these OS materials the CeO₂ or other redox active oxide is employed to buffer the catalyst from local variations in the air/fuel ratio during typical catalyst operation e.g. during the active CDPF regeneration cycle or other transient event. They do this by ‘releasing’ active oxygen from their 3-D structure in a rapid and reproducible manner under oxygen-depleted transients, ‘regenerating’ this lost oxygen by adsorption from the gaseous phase under oxygen-rich conditions. This activity is attributed to the reducibility (reduction−oxidation or redox activity) of CeO₂ via the 2Ce⁴⁺→2Ce³⁺ [O₂] reaction. This high availability of oxygen is critical for the promotion of generic oxidation/reduction chemistries e.g. CO/NO chemistry for the gasoline three-way catalyst, or more recently for the direct catalytic oxidation of particulate matter (soot) in the CDPF e.g. US2005 0282698 A1, SAE 2008-01-0481.

Hence there have been extensive studies on the chemistry, synthesis, modification and optimisation of Ce—Zr based OS materials. For example, the use of Ceria-Zirconia materials doped with lower valent ions for emission control applications have been extensively studied e.g. U.S. Pat. No. 6,468,941, U.S. Pat. No. 6,585,944 and US2005 0282698 A1. These studies demonstrate that lower valent dopant ions such as Rare Earth metals e.g. Y, La, Nd, Pr, etc., Transition metals e.g. Fe, Co, Cu etc. or Alkaline Earth metals e.g. Sr, Ca and Mg can all have a beneficial impact upon oxygen ion conductivity. This is proposed to arise from the formation of oxygen vacancies within the cubic lattice of the solid solution which lowers the energy barrier to oxygen ion transport from the crystal bulk to the surface thereby enhancing the ability of the solid solution to buffer the air fuel transients occurring in the exhaust stream of a typical gasoline (three-way) catalyst application.

Additionally it has been shown (U.S. Pat. No. 6,468,941 and U.S. Pat. No. 6,585,944) that the use of specific examples of the above dopants can provide full stabilisation of the preferred Cubic Fluorite lattice structure for Ceria-Zirconia solid solutions, with Y being identified as having particular benefit hereto. The presence of the preferred Cubic Fluorite structure has been found to correlate with the most facile redox chemistry for Ce⁴⁺⇄Ce³⁺, from both the surface and bulk of the crystal, thus dramatically increasing the oxygen storage and release capacity, as compared to bulk CeO₂. This benefit is especially pronounced as the material undergoes crystal growth/sintering due to the hydrothermal extremes present in typical exhaust environments. The incorporation of especially Y and to a lesser extent La and Pr have also been demonstrated to limit or, in certain cases, circumvent the disproportionation of the single cubic phase Ceria-Zirconia into a composite consisting of more Ce-rich cubic phases and more Zr-rich tetragonal phases, a process which results in marked decrease in redox function, surface area etc. of the solid solution.

Finally U.S. Pat. No. 6,468,941 and U.S. Pat. No. 6,585,944 teach the potential for employing base i.e. non-precious group (Pt, Pd, Rh, Au etc.) dopant metals into the Cubic Fluorite lattice of the solid solution as an alternative means to promote the redox chemistry of Ce, with Fe, Ni, Co, Cu, Ag, Mn, Bi and mixtures of these elements being identified as of particular interest. Hence while typical non-promoted OS materials typically exhibit a redox maximum, as determined by H₂ Temperature Programmed Reduction (TPR), at ca. 600° C., the inclusion of base metals within the lattice can decrease this temperature by >200° C. at a fraction of the cost incurred by the use of precious metals.

However, while these base metals can be beneficially incorporated in the CeZrOx lattice and this incorporation can significantly promote low temperature redox function for fresh materials, the addition of these elements can also decrease fresh and aged phase purity and significantly decrease hydrothermal durability (promote crystal sintering and material densification), leading to losses in aged performance cf. base compositions without additional base metal. In addition during conventional aging cycles reactions may occur between the gas phase and the CeZr material which can result in extraction of these additional base elements from the Cubic Fluorite lattice. This in turn can result in formation of separate bulk phase(s) with low intrinsic catalytic activity or in a worst case scenario, phases which directly interact with the OS or other catalyst component resulting in a direct or indirect poisoning of the catalyst.

Thus, the aforementioned materials are potentially limited in their scope. For example, while lower valent ions may be successfully incorporated in the synthesis of a solid solution this can only be achieved by careful control of the synthesis and within specific limits for the final composition. This is necessary to ensure both the electrical neutrality and the preservation of the favoured Cubic Fluorite single-phase structure of the resultant compound. Hence, for example, the synthesis of an OS material containing a specific low valent base metal promoter ‘doped’ into a Cubic Fluorite structure with high Ce (>50 mol %) and/or low Zr (<30 mol %) contents is not facile and there is significant potential that the synthesis could result in a material with disproportionation into Ce-rich and Ce-poor domains, with a marked decrease in performance.

Similarly great care must be taken to balance the ultimate electrical ‘charge’ of the solid solution, hence the incorporation of Nb⁵⁺ in the cubic lattice may also be achieved but only by introduction of equimolar quantities of Y³⁺, in order to preserve the overall cationic charge balance of 4⁺. Again any imbalance or heterogeneity of Nb/Y content within the local crystal structure is undesirable and could lead to phase stability and purity issues with ultimate loss of required redox function as outlined in U.S. Pat. No. 6,605,264.

A further, and perhaps more significant, drawback of introducing low valent base metal ions within the Cubic Fluorite lattice is that the ions are dispersed throughout the bulk of the crystal structure and thus the surface concentration of the ions may be very low. This in turn limits the extent of the dopant ions to interact directly with the exhaust environment. Thus, while it is possible to dope Sr, Ca and Mg etc. into the cubic lattice the ability of these ions to provide additional chemical functionality e.g. as a NOx trap to provide transient adsorption of NO and NO₂ is limited by the available concentrations of ions in the surface and immediate sub-surface of the crystal.

Additionally while the CDPF has been demonstrated as a highly effective method to address particulate emissions for diesel vehicles, the current state-of-the-art technology does posses certain limitations. Firstly the wall-filter introduces a large back-pressure penalty i.e. a restriction for exhaust flow, resulting in a loss in engine performance due to work being performed to force the flow through the filter. This backpressure increases when the filter is wash-coated and increases still further during normal operation as the filtered soot accumulates on the filter wall increasing the thickness of restriction the exhaust flow must overcome. Secondly, the CDPF requires a method to enable combustion of the soot filter cake and thus ‘regenerate’ the ‘clean’ filter. At this time a fully passive and continuous soot regeneration technology has not been demonstrated on a vehicle and hence the regeneration of the filter requires an ‘active’ or forced regeneration strategy. The active regeneration cycle is achieved by the introduction of ‘sacrificial’ fuel species into the exhaust. These species are catalytically oxidised, typically over a DOC positioned prior to filter within the exhaust train, to achieve a transient thermal ‘bloom’ within the filter which initiates the conversion of the trapped soot into CO₂ and H₂O, e.g. see SAE paper 2008-0100481 and references therein which is incorporated herein by reference.

However, the combustion of sacrificial hydrocarbon species to produce the thermal bloom required for regeneration imposes a substantial and unattractive fuel penalty i.e. an additional and ongoing operational cost. Moreover, the implementation of an active emissions control strategy requires complex and accurate engine management protocols to avoid incomplete regeneration and/or untreated emissions. In addition, soot combustion initiated in this manner results in a phenomenon known as ‘oil dilution’ which can both adversely affect engine operation and results in ash deposition (inorganic salts) within the filter which impact the back pressure, soot capacity and catalytic performance of the filter. Finally, it is known that active regeneration proceeds in a more homogeneous i.e. non-catalytic manner and can lead to uncontrolled regeneration. This, in turn, can result in localized exothermic ‘hotspots’ of T>1000° C. which can damage the physical properties of the formulation required for high catalytic efficiency, e.g. PGM sintering, surface area/porosity collapse. In the worst case, catastrophic uncontrolled regeneration can destroy the monolith through thermal degradation or even melting of the monolith.

Many attempts have been made to address or limit the extent of the issues related to the active regeneration strategy. Such efforts are exemplified by attempts to introduce passive regeneration strategies based upon the use of the redox chemistry of advanced OS materials, e.g. US 2005/0282698 A1. In these studies it was shown that decreases in the temperature required for soot oxidation may be achieved by utilisation of active oxygen species derived from a redox active washcoat material, typically Ce—Zr-based Cubic Fluorite solid solution. However, attempts to employ this methodology in vehicular applications have met with limited success. Extensive studies of the chemistry occurring in these systems have demonstrated that the activity of the OS-based catalyst is dependent upon high ‘Contact Efficiency’ between the OS material and the soot, e.g. see, Applied Catalysis B. Environmental 8, 57, (1996). Subsequent studies, described in SAE paper 2008-01-0481 have now identified that the loss of contact efficiency between the OS and soot arises from specific chemistries involving the significant NO engine emissions typical of pre-EuroV legislation engines. This process has been denoted as ‘de-coupling’ of the OS and soot and is the result of the reaction of engine out NO over oxidized PGM to produce NO₂ which combusts the soot in the immediate environment of the catalyst producing CO+NO. The NO byproduct of this process is further ‘recycled’ to NO₂ and the soot combustion re-initiated, again removing only that soot which immediately contacts the catalyst. This cycle is the basis of U.S. Pat. No. 4,902,487 and previously believed to be the major reaction providing low temperature soot combustion/regeneration. However, this mechanism is only effective at removing low concentrations of soot and indeed only that proportion of soot in direct contact with the catalyst. Hence, this mechanism effectively ‘de-couples’ the catalyst and soot and dramatically decreases the effectiveness of the OS-mediated regeneration method and may in fact be considered to be a reactive poison which effectively ‘deactivates’ the ‘true’ OS mediated low temperature, passive, soot regeneration reaction required for optimum soot emission control.

What is needed in the art are durable catalytic materials capable of direct soot oxidation at lower temperatures due to their facile and high oxygen storage and oxygen ion conductivity properties. Such materials should additionally provide an effective means of initiating diesel soot oxidation at lower temperatures without ‘de-coupling’ by NOx-based chemistry. Moreover such materials should be able to achieve the aforementioned benefits in ‘real-life’ conditions that is to say as conventional wash-coated materials deposited upon typical wall-filter DPF devices.

### SUMMARY OF THE INVENTION

Significant improvements in the performance of Oxygen Storage (OS) materials based upon ZrO₂/CeO₂ solid solutions containing a substantially phase pure Cubic Fluorite structure may be achieved by specific ion exchange of base i.e. non-precious group metals. The ion exchange process described herein is performed under chemically basic i.e. conditions of high pH, that is say high OH⁻/low Hydronium (H₃O⁺) or proton (H⁺) content. The basic ion exchange process is in a discrete, post-synthetic modification and hence provides for markedly higher flexibility of composition, dopant ion type and concentration as compared to conventional direct synthetic methods as described in previous work (U.S. Pat. No. 6,468,941 and U.S. Pat. No. 6,585,944). The resultant materials demonstrate high activity and hydrothermal durability under all aging conditions examined. This is in contrast to promotion that may be realised by conventional impregnation of an acidic metal e.g. metal nitrate where formation of bulk oxide phases in fresh materials and rapid sintering of such oxide phases which resultant deactivation, is the norm. Thus the method developed provides a wide, and novel, range of materials of stable and highly active OS applications for both gasoline and diesel vehicles. Moreover, the method of this invention enables choice and tailoring of the base metal promotant to introduce specific chemical synergies to incorporate or enhance additional catalytic functions, e.g. lean NOx control.

Specifically, high redox activity can be obtained by the modification of solid solutions based on Ce—ZrOx by a mechanism which is proposed, while not wishing to be bound by theory, to involve the basic/alkaline exchange of the pre-existing Ce—OH hydroxyl defect sites that exist within all OS materials. The Ce—OH sites are believed to arise at Ce³⁺ defect sites within the lattice and the presence of the proton of the hydroxyl group being a requirement for electrical neutrality of the lattice. The exchange of the H⁺ atom by metal ions enables the incorporation and stabilisation of specific mono-valent (e.g. K⁺), di-valent (e.g. Cu²⁺), tri-valent (e.g. Fe³⁺) and higher valence ions of very high dispersion (which may approach atomic levels of dispersion) within the oxide matrix. The choice of base metals to be incorporated within the mixed oxide in this manner can additionally be based upon oxides known to be active for reactions of especial interest or catalytic importance. Examples include, but are not limited to, direct catalytic soot oxidation, low temperature SCR (Selective Catalytic Reduction by urea, NH₃ or hydrocarbons), NOx trapping, low temperature CO—NO or CO—O₂ reaction promoters, hydrocarbon cracking function (e.g. by increasing the acidity of the OS), etc. Metals appropriate to these examples include Ag, Cu, Co, Mn, Fe, alkali metals, alkaline earth metals or transitions metals, or other metal or metalloid known to form a stable nitrate which can undergo subsequent decomposition and reduction N₂ under conditions within the conventional operational window of the vehicle exhaust. The term “transition metal” means the 38 elements in Groups 3 to 12 of the Periodic Table of Elements.

Prior developments in this field are described in U.S. Pat. Nos. 6,585,944 and 6,468,941, although in these patents the Ce—ZrO₂ system is used as a host matrix into which other catalytically active ions are introduced in a deliberate modification of the normal synthetic method. The incorporation of active ions in this way, while successful, does impose specific limits upon the types of dopants which may be introduced as well as their concentrations within the lattice i.e. the maximum ‘solubility’ in the solid which still provides the favoured substantially phase pure cubic fluorite structure, known to provide the optimal redox characteristics for the OS material. In contrast in the present invention the association of the promotant occurs post-synthesis, and while not wishing to be bound by theory, via a specific ion exchange mechanism and the ions thus introduced and incorporated in a range of sites associated with the Ce³⁺—OH defects and not in any well defined and unique cationic position. Hence, the method of the present invention enables the introduction of higher concentrations of the base metal ions/oxide component since the loading is not limited by its solubility within a well-defined mixed oxide matrix of phase purity. Conversely, the loading of effective promotant is limited by the concentration of structural hydroxls within the lattice as are typically associated with point defects or surface terminations of primary crystals.

In this application, we take advantage of the favourable structural matrices of ZrOx, Zr—CeOx and Zr—Ce—REOx (RE=Rare Earth) crystal structures with their proven hydrothermal durability into which the (redox) active metal ions can be dispersed with high (atomic) dispersion without negatively impacting their redox function. In fact, as is shown in the included examples by this process one can achieve a dramatic and durable proinotion of the normal redox characteristics of OS materials. An analogy to this idea is the addition of Ce⁴⁺ to the ZrO₂ matrix. The role of Ce in the catalytic oxidation of CO for example is based upon its redox activity as follows: Ce³⁺+O₂→O₂⁻+Ce⁴⁺, followed by reaction of the O₂⁻ anion with CO (NO) to give CO₃ (NO₃) and subsequent decomposition to CO₂ (NO₂) and O⁻ and finally regeneration of Ce³⁺. This reaction cycle can occur on pure CeO₂ and the nature/energy barrier of the Ce⁴⁺⇄Ce³⁺ redox cycle can be probed using TPR (Temperature Programmed Reduction) with reduction peaks for surface CeO₂ at 350-600° C. No bulk CeO₂ is reduced at these temperatures the crystal lattice of the CeO₂ cannot accommodate the formation of the larger Ce³⁺ ion and hence O mobility away from the bulk in order to preserve electrical neutrality cannot occur. However, when Ce⁴⁺ ions are dispersed into the ZrO₂ lattice the redox activity of Ce⁴⁺ is not negatively impacted but in fact is greatly enhanced, not primarily through modification of the inherent chemistry/reducibility of the Ce⁴⁺ ion itself but more by a geometric mechanism as noted above where all the Ce⁴⁺ ions are now accessible. Further, the presence of the ZrO₂ matrix greatly stabilises the material from surface area loss, crystallite growth and loss of porosity. ZrO₂ may also inhibit or protect Ce⁴⁺ from formation of undesirable stable compounds with the acidic exhaust components such as CO₂ and SO₂ due to the inherent acidity of ZrO₂ relative to CeO₂.

By analogy to these conventional CeO₂ vs Ce—ZrO₂ systems, we now provide a similar beneficial and synergistic system that can be built using the (redox) active elements through a specific strong association through ion exchange. Thus, the present invention relates to a method of making a OIC/OS host material for treatment of exhaust gases comprising forming a solid solution of a substantially cubic fluorite Ce—ZrOx material as determined by conventional XRD, introducing a base metal element in said material by exchanging pre-existing hydroxyl sites in said Ce—ZrOx material, under high pH conditions, to thereby incorporate and stabilize said base metal element in high dispersion within said Ce—ZrOx material.

The Ce—ZrOx material of the invention is an OIC/OS material having about 0.5 to about 95 mole % zirconium, about 0.5 to about 90 mole % cerium, and optionally about 0.1 to about 20 mole % R, wherein R is selected from the group consisting of rare earth metal(s), alkaline earth metal(s), and combinations comprising at least one of the foregoing, based upon 100 mole % metal component in the material.

In a further aspect, the Ce—ZrOx material is an OIC/OS material based upon 100 mole % of the material comprising up to about 95 mole % zirconium; up to about 90 mole % cerium; up to about 25 mole % of a stabiliser selected from the group defined in the standard Periodic Table as rare earths, and combinations thereof comprising at least one of the stabilizers.

In carrying out the method of the invention, the base i.e. non Precious Group metal element is prepared as an alkaline solution, for example as an ammoniacal solution (ammonium hydroxide based solution) with a high pH as for example 8.0 to 9.5. The base metal can be a member selected from the group consisting of transition metals, alkali metals, and alkaline earth metals. Alternatively, the base metal element can also be introduced as a base metal complex with an organic amine in such cases where stable ammoniacal base metal solutions cannot be prepared.

The solution of the base metal as defined herein and the Ce—ZrOx solid material are mixed together to form a moist powder or paste. After drying the mixture is then calcined.

As an optional step, a platinum/precious group metal can be added to the OIC/OS material in the conventional way.

Benefits and features of the present invention include:

a) provision of an OS material with enhanced low temperature reactivity and excellent hydrothermal durability;

b) no disruption of activity and ancillary catalytic functions of the ion-exchanged adatoms e.g. NOx trap/SCR, etc.;

c) improved performance due to the enhanced stability, higher dispersion and hence high accessibility of the gaseous reactants to the redox active elements;

d) advantage of pre-formed OS materials with desirable structural and textural properties e.g. single phase cubic systems, meso-porous systems of high and durable pore volume and SA (surface area) and hence, further enhance the associated performance benefits of post-modification;

e) greater flexibility in chemical modification with minimal disruption of lattice parameter, phase purity, defect density, surface acidity basicity, etc.;

f) the provision of a specific-post modification method for generic pre-existing commercial materials to produce a range of tailored and bespoke materials with characteristics and properties “tuned” to a specific application.

This strategy contrasts to that employed in the conventional OS material syntheses in which it is typical to employ expensive precious metals doping to attempt to achieve the scope of the goals outlined above.

This strategy is especially advantageous as conventional OS materials are known to possess various limitations.

Firstly, there is a requirement for increased Ceria reducibility at lower temperatures than is conventionally obtained with binary, tertiary or even quaternary Ce—Zr—REOx systems. These materials typically exhibit a redox maximum, as determined by H₂ Temperature Programmed Reduction (TPR) at ca. 600° C. This imposes the requirement for high exhaust gas/reaction temperatures in the application in order for the OS material to provide the maximum “buffering” or oxygen donation benefit. In order to address this temperature issue OS materials are typically “promoted” by the addition of a Precious Group Metal (PGM) component, e.g. Pt, Pd or Rh. However, promotion by these metals contributes a very significant additional cost to the price of the emission control system.

Secondly, typical OS materials used to date present limitations with regard to their total Oxygen Storage Capacity, that is to say the amount of available oxygen as measured by TPR is typically lower than that expected from consideration of the total Ce IV content of the OS material. Many data available to date are consistent with as little as only ca. 50% of the total Ce IV available undergoing reduction. At this time it is uncertain whether this is due to a fundamental issue, or due to limitations with the current synthetic method(s) employed in the manufacture of the OS material leading to a mixed Ce IV/Ce III valency or whether a combination of additional chemical, structural or textural limitations are responsible.

Finally, typical OS materials provide only limited, if any, additional synergies to the emission control system. As described elsewhere, ideal material components provide additional integrated chemical mechanisms to further enhance emissions control, e.g. NOx scavenging and reduction to N₂.

Hence, while OS materials are key components in realising highly active and durable vehicular exhaust emissions systems the pre-existing synthesis methods and materials present significant limitations to development of the next generation of exhaust catalyst that will be required to comply with newer and ever more stringent emission targets. What is required is a new class of OS materials that are active at lower temperatures, especially the Cold Start portion of vehicular applications to promote catalytic function. These OS materials should also display high hydrothermal durability and be tolerant to potential exhaust poisons in order to enable their use in the wide range of demanding exhaust environments.

The above-described and other features will be appreciated and understood by those skilled in the art from the following detailed description, drawings, and appended claims

### BRIEF DESCRIPTION OF THE DRAWINGS

OS1=44% CeO₂; 42% ZrO₂/HfO₂; 9.5% La₂O₃; 4.5% Pr₆O₁₁

OS2=40% CeO₂; 50% ZrO₂/HfO₂; 5% La₂O₃; 5% Pr₆O₁₁

OS3=31.31% CeO₂; 58.48% ZrO₂/HfO₂; 5.05% La₂O₃; 5.15% Y₂O₃

All compositions quoted as wt %

FIG. 1 shows the dramatic promotion of H₂ TPR characteristics of a CeZrLaPrO₂ OS (OS1) by the post-synthetic modification by basic ion exchange of 2% Silver (Ag). The exchange of the proton of the Ce³⁺—OH by Ag is clearly highly beneficial for the oxygen ion conductivity of the material. This is ascribed to the elimination of the de-hydroxylation (and subsequent generation of lattice vacancies) phenomenon described in DP315579A which appears to be a requirement for the activation of the bulk of the crystal lattice to become redox active.

FIG. 2 summarises an analysis of soot combustion using a conventional TGA method (SAE paper 2008-01-0481). The data contrasts the performance of OS2 versus 5% Ag OS2 samples prepared by either basic ion exchange or by conventional impregnation of AgNO₃. The conclusion is unambiguous, the performance of OS2 and 5% Ag-Nitrate-OS2 are equivalent with a peak rate of soot oxidation occurring at ca. 375° C. In contrast the 5% Ag basic OS2 decreases the temperature for active/direct catalytic soot oxidation to ca. 325° C. Thus one can confirm that the basic exchange mechanism provides a specific promotion of redox and other catalytic functions that is not seen for conventional impregnation of acidic e.g. nitrate metal precursors.

FIG. 3 depicts the soot oxidation performance for OS2 versus Cu and Co ion exchanged OS2 variants. Again the post-synthetic modification of the OS yields enhanced performance lowering the soot oxidation temperature by 15 and 25° C. for 1% Co and 2.5% Cu respectively.

FIG. 4 provides a further example of enhanced soot oxidation rate by ion exchanged OS. In this case OS3, a lower Ce content OS and thus expected to be weaker performance than higher Ce OS (SAE paper 2008-01-0481), is modified by exchange of 2.5% Cu. The resulting performance enhancement is dramatic and with modified material now offering performance competitive with higher Ce-content OS materials.

FIG. 5 compares the performance of OS1 against fresh and hydrothermally aged (800° C./air/steam/6 h) 2% Ag exchanged OS1 and confirms the exchange process produces a material of enhanced intrinsic activity towards direct soot oxidation and that the promotion is maintained after aging.

FIG. 6 illustrates the activity of 1 g of 0.75% Pt-49.625% OS1-49.625% Al₂O₃ catalyst intimately mixed 4:1 with Printex U (artificial soot analogue) in a synthetic gas bench (SGB) soot combustion test. Herein the sample is heated from an inlet temperature of 50° C. to 400° C. and the CO/HC T₅₀-s and soot combustion temperature are recorded. The reaction was performed using 1000 ppm CO, 100 ppm NO, 750 ppm Cl from n-Octane, 3.3% CO₂, 13.2% O₂, 3.5% H₂O, N₂ balance @ 5 L/min and shows that whilst CO and HC are oxidised, there is no soot combustion event in the temperature range examined. Key: O—CO conversion, Δ—HC conversion, ▾—Bed temperature.

FIG. 7 illustrates the activity of an equivalent 1 g sample of 0.75% Pt-49.625% OS1-49.625% Al₂O₃ mixed 4:1 with Printex U tested under identical conditions to FIG. 6, except the reactive gas stream contained 0 ppm NO. Again CO and HC conversion proceed as expected, however in this instance there is clear evidence for soot combustion at an inlet temperature of 230° C. (block temperature of ca. 200° C.) wherein sudden large decreases in CO and HC conversion are evident, coincident with a bed exotherm of several hundred degrees. These responses can only be attributed to direct catalytic soot combustion and suggest that the presence of NO, and more likely NO₂, is highly antagonistic to direct catalytic soot oxidation, phenomenon dubbed ‘de-coupling’ which is described in further detail in SAE paper 2008-01-0481. Key: O—CO conversion, Δ—HC conversion, ▾—Bed temperature.

FIG. 8 summarises the impact of addition of 10 wt % of NOx trapping component to 0.75% Pt-49.625% OS1-49.625% Al₂O₃ catalyst, tested in the SGB under the conditions listed in FIG. 6. Herein the use of a NOx trap results in marked decreases in the temperature required to initiate direct soot oxidation. However, the use of bulk K₂O and SrO salts can be seen to have a negative impact upon CO/HC conversion. However the performance of 2Ag—OS1, is of most interest. Herein the CO/HC penalties are decreased vs K₂O, at 0 PGM content, but more importantly the soot oxidation characteristic is identical to the 0 ppm NO test (FIG. 7), indicating that by circumvention of decoupling one can enable the full soot oxidation activity of the OS. This data is of particular significance since it highlights a twofold synergistic benefit of basic exchange of Ag into the OS. Firstly there is aforementioned promotion of redox characteristic with subsequent promotion of direct soot oxidation. Secondly the highly dispersed Ag species is clearly acting as a NOx scavenger thereby disabling the ‘de-coupling’ mechanism which limits direct OS-soot contact under application conditions.

FIGS. 9a and 9b further compare and contrast the activities of OS1 vs 2% Ag-exchanged OS1 for direct soot oxidation catalysis. In FIG. 9a the performance in conventional soot TGA vs oxidation in the SGB show excellent correlation for a comparison of the TGA mass loss event and the peak bed exotherm in the SGB (test performed as per FIG. 6 using an inlet 70 gcf Pt DOC followed by 1 g powder mixture of OS: Printex U @ 4:1 using a reactive gas mix of 1000 ppm CO, 100 ppm NO, 75 ppm Cl from propene, 75 ppm Cl from methane, 3.3% CO₂, 13.2% O₂, 3.5% H₂O, N₂ balance @ 5 L/min). These data confirm that in the absence of de-coupling by NOx, the intrinsic activity of the OS is maintained. Moreover the data confirm that NO₂ production ‘ex-situ’ i.e. not at the interface between the OS and soot, does not ‘de-couple’ contact cf. FIG. 6 where Pt is directly supported on OS1. Further examination of the NOx chemistry (FIG. 9b) highlights the synergistic role of the dispersed Ag as a NOx trap. Herein one can see a large desorption of NO₂ coincident with the combustion of soot for the 2% Ag—OS1. For the undoped OS1 there is no significant uptake nor desorption of stored NOx. At this juncture it should be stressed that NOx desorption is only associated with soot oxidation and is not responsible for the initiation of soot combustion, hence the identical performance seen on SGB at 100 ppm NOx and on the TGA at 0 ppm NOx.

FIG. 10 illustrates a further example of the application of the ion exchange method to introduce a synergistic NOx trapping chemistry in the OS. In this instance an alkaline earth metal (Ca) has been introduced, via basic exchange method, into the OS to provide lean NOx trapping and release function. Ca was introduced at 1 or 2.5% into OS1, OS4 (31.5/58.5/5/5-CeO₂/ZrO₂/La₂O₃/Y₂O₃) and OS5 (74/24/2-CeO₂/ZrO₂/La₂O₃). The resultant materials were tested in a conventional synthetic gas bench for NOx uptake and release. The exchanged materials were placed in the reactor after a conventional Pt diesel oxidation catalyst (70 g/ft³ Pt loading) and heated to 250° C. in the full reactive gas flow (1000 ppm CO, 930 ppm Cl HC (600 N-Octane, 180 Toluene, 75 Propene 75 Methane), 200 ppm NO, 3.5% H₂O, 3.5% CO₂), at a ramp rate 12° C./min and flow of 5 slpm. The sample was allowed to ‘saturate’ at 250° C. for 10 minutes and then heated to 600° C. and the desorption of any stored NOx (NO₂ and NO) monitored giving the desorption traces shown in FIG. 10. The traces are normalised to the response of an inert δ, θ-Al₂O₃ sample tested under identical conditions and confirm NOx uptake and release for all samples tested. Of particular interest in the observation that the choice of OS clearly affects the temperature of peak desorption. This is contrast to the use of bulk CaO, and in principle allows one to manipulate the materials to directly tailor the desorption regime to fit specific application requirements.

FIG. 11 summarises the results of engine Dynamometer (Dyno) soot regeneration tests for conventional mixed oxide catalysts versus uncoated cordierite filter. The OS materials were comparable CeZrLaPrO₂ compositions provided by suppliers A, B and C. The parts were loaded as described in SAE paper 2008-01-0481 with 5 g/L soot, using a cycle designed to provide low SOF (soluble organic fraction) i.e. soot of low reactivity, and subjected to a standard post-injection regeneration cycle with initial inlet filter 300° C., flow 100 kg/h, post-injection ramp 0-60 s, post-injection 600 s, initial inlet DOC 350° C. with post-injection to target an inlet filter temperature of 550° C. The data confirms that conventional OS systems offer no benefit for direct catalytic soot oxidation to an uncoated filter. (Note the data is an average of 2 load/regeneration cycles).

FIG. 12 contrasts the Dyno performance of degreened 2% Cu OS1 and 2% Ag OS2 in dyno regeneration testing versus a conventional CeZrPrO₂ and a blank Cordierite Filter. Parts were again loaded with 5 g/L soot, the inlet filter was 300° C., flow 100 kg/h, post-injection ramp 0-60 s, post-injection 600 s, inlet DOC 350° C. to target an inlet filter temperature of 550° C. In this case there is a small advantages for the 2% Cu OS1 but a marked and clear improvement in performance for the 2% Ag OS2, reflecting that even under conditions relevant to a ‘real-life’ application the ion exchanged material provides a clear benefit in increased regeneration efficiency at lower temperatures. (Again the data is the average of 2 load/regen cycles).

FIG. 13 shows the performance of the same parts tested in FIG. 12 after catalyst aging. The aging comprised 20 soot loading and regeneration cycles followed by 20 h at 650° C. in reactive gas flow on the engine dyno. Again the filters were loaded with 5 g/L soot and regenerated with an inlet filter of 300° C., flow 100 kg/h, post-injection ramp 0-60 s, post-injection 600 s, inlet DOC 350° C. to target an inlet filter temperature of 550° C. herein one can see that the 2Cu OS1 sample has deactivated during the aging and no longer offers any performance benefit. In contrast the 2% Ag OS2 sample has maintained a significant regeneration efficiency benefit, confirming its suitability for vehicular applications. (Data is average of 2 load/regen cycles)

FIG. 14 depicts the impact of OS loading on soot regeneration efficiency during a standard driving cycle (MVEG) for aged (20 h 650° C. in reactive gas flow on dyno) 2% Ag exchanged OS1 mixed oxide catalysts versus conventional OS-based washcoat coated filter. Testing was performed as oxide only with zero PGM load. Soot loading and regeneration were performed on a Mercedes vehicle equipped with a 2.2 L 646 EVO engine (Euro4 engine). Soot loading was performed under transient driving conditions with ca. 8 g/L loaded using multiple ECE cycles (urban driving cycle) to attain target load. Regeneration was performed during the ECE portion of the MVEG, the initiation of regeneration occurring at first cut off condition into ECE and maintained for ca. 800 s i.e. until the last idle of the ECE prior to the start of the EUDC cycle (extra urban/highway driving). In these studies the target regeneration/filter inlet temperature was 580° C. versus 620° C. in the OEM calibration, however the average temperature during regeneration was monitored and found to ca. 520° C. In all cases the 2% Ag OS1 coated filters show superior regeneration efficiency, ca. 10-20%, compared to the conventional OS coated filter. Moreover the magnitude of the benefit is directly proportional to washcoat loading. At 0.19 g/in³ regeneration efficiency is 91% rising to 96 and 98% at 0.33 and 0.65 g/in3 respectively. This linear response is consistent with increased interfacial catalyst-soot contact with increasing washcoat load consistent with this requirement for direct catalytic soot oxidation. More importantly the promotion of soot oxidation is far smaller for the conventional CeZrLaPrOx catalyst, confirming the benefit of the ion exchanged OS for direct soot oxidation.

FIG. 15 is an illustration of a typical particulate filter device (100) of the invention comprised of a substrate (16), housing (18), exhaust inlet (24), conical portion (20), retention material (14), and channels (12) coated with redox action material.

### DETAILED DESCRIPTION OF THE INVENTION

The present invention relates to a modified host for an emission treatment catalyst and method for making the same. The host is a substantially phase pure cubic fluorite (as determined by XRD method) of the Ce—ZrOx type which is well known in the art. The modification is proposed to arise, whilst not wishing to be bound by theory, from an ion exchange of the Ce³⁺—OH hydroxyls, present in both the surface and to a lessor extent in the bulk of the crystal, by the base metal element/ion selected for this purpose.

The modified host materials may be applied advantageously to a wide range of emission control catalysts serving both so called gasoline (stoichiometric) and diesel (or other fuel lean) applications. One particular example described herein for the application of these materials is in the area of catalytic oxidation/regeneration of diesel particulate matter captured and ‘stored’ on a conventional wall flow filter. This new generation of modified OS materials has been demonstrated as having particular benefit in affecting either lower temperature regeneration/oxidation of soot or an increased regeneration efficiency at a lower temperature as compared to non-modified OS materials. This example is not exclusive, merely illustrative of the potential benefits that may be realised by employing active materials produced by this novel post-synthetic modification method.

It should be further noted that the terms “first”, “second” and the like herein do not denote any order of importance, but rather are used to distinguish one element from another, and the terms “a” and “an” herein do not denote a limitation of quantity, but rather denote the presence of at least one of the referenced items. Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired” is inclusive of the endpoints and all intermediate values of the ranges, e.g. “about 5 wt. % to about 25 wt. %, about 5 wt. % to about 15 wt. %” etc.

The basic exchange for enhanced redox process describes a method for the modification of conventional cerium-zirconium-based mixed oxides, also known as, oxygen storage materials (OSM). The process involves the treatment of the OSM with a basic, where possible preferentially ammoniacal metal solution. Base metals i.e. common metals, currently being employed in this process include, but are not limited to, transition metals, e.g. silver, copper and cobalt, alkali metals e.g. potassium, alkaline earth metals e.g. calcium, strontium, barium. In those instances where the base metal required for exchange do not form air stable ammoniacal complexes e.g. aluminium iron or alkaline earth metals, stable basic complexes of organic amines or hydroxides may be employed. The term “transition metal” as used herein means the 38 elements in groups 3 through 12 of the Periodic Table of the Elements.

The variables in the process include (1) the OSM/mixed oxide selected, (2) the metal used, and (3) the concentration of that metal. Metal concentrations successfully employed have ranged from 0.02 to 5.0 weight-percent. However, at higher metal exchange levels bulk metal oxides may be formed which do not retain the synergistic coupling with the OSM. Hence, the most preferred range for ion exchange is 0.1 to 2.5 weight-percent.

The base metals are typically received as a metal salt or solution of salt e.g. nitrate. As indicated, most base metals form a water-soluble complex with ammonium hydroxide. In those instances wherein the ammoniacal complex is unstable an organic amine e.g. tri-ethanolamine may be employed instead. In the process, the solution of an acidic metal solution is converted to a chemically basic form by addition of the ammoniacal base. The chemistry and amounts of base used vary with the metal used. The resulting solution is then used to impregnate the mixed oxide powder, thereby ion-exchanging the surface and sub-surface Ce—OH hydroxyls (surface terminations and bulk defects which act as acidic centres under the conditions of synthesis). It is this exchange process which is believed to be responsible for the improvements in the redox behaviour of the thus modified mixed oxide. The impregnated mixed oxide must first be calcined at sufficient temperature to decompose the inorganic anions (e.g. nitrate and ammonium ions), typically >350° C. After calcination the metal that was added is now bound to the former Ce—OH centres.

The mixed oxide/OSM material of this invention comprises any known or predicted Cerium-containing or Ce—Zr-based stable solid solution. Preferably, the solid solution contains a cationic lattice with a single-phase, as determined by standard X-ray Diffraction method. More preferably this single-phase is a cubic structure, with a cubic fluorite structure being most preferred. Additionally it is noted that the ion exchange process may be performed without formation of additional bulk phase, as determined by XRD, providing the concentration of exchanged cation does not exceed the Ce—OH ‘concentration’ of the cubic fluorite lattice. In various embodiments, the OS material may include those OS materials disclosed in U.S. Pat. Nos. 6,585,944 6,468,941 6,387,338 and 6,605,264 which are herein incorporated by reference in their entirety. However, the flexibility of the basic exchange provides for the modification of all current known Cerium oxide and Ce—Zr-based solid solution materials to be thusly modified and enhanced.

The OS materials modified by the basic exchange method comprise a composition having a balance of sufficient amount of zirconium to decrease the reduction energies of Ce⁴⁺ and the activation energy for mobility of ‘O’ within the lattice and a sufficient amount of cerium to provide the desired oxygen storage capacity. In another embodiment the OS shall contain a sufficient amount of stabiliser e.g. yttrium, rare earth (La/Pr etc.) or combination thereof to stabilise the solid solution in the preferred cubic crystalline phase.

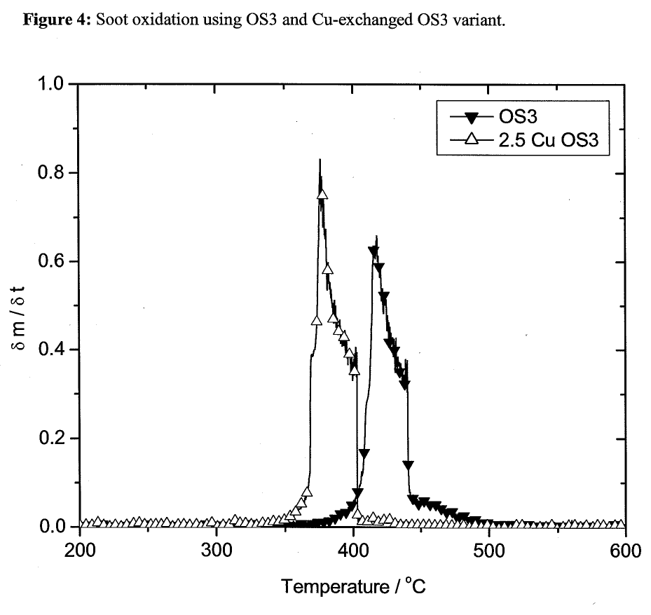

The OS materials modified by the basic exchange method shall preferably be characterised by a substantially cubic fluorite structure, as determined by conventional XRD methods. The percentage of the OS material having the cubic structure, both prior and post exchange, is preferably greater than about 95%, with greater than about 99% typical, and essentially 100% cubic structure generally obtained (i.e. an immeasurable amount of tetragonal phase based upon current measurement technology). The exchanged OS material is further characterised in that it possess large improvements in durable redox activity with respect to facile oxygen storage and increased release capacity e.g. as determined by H₂ Temperature Programmed Reduction (TPR) method. Thus, for Cu exchanged solid solutions, for example, the reduction of Ce+Cu is observed to occur at a temperature of about 300 to about 350° C. lower than would occur in the absence of the Cu dopant (FIG. 4). In the case of iron, the Ce+Fe reduction is shifted to lower temperatures by about 100 to about 200° C.

In an exemplary embodiment, the OS material, based upon 100 mole % of the material preferably comprises up to about 95 mole % zirconium; up to about 95 mole % cerium; up to about 20 mole % of a stabiliser or stabilisers selected from the group consisting yttrium, rare earths and combinations comprising at least one of the stabilizers.

In another embodiment, the OS material prior to exchange is solid solution of Ce—Zr—R—Nb, wherein “R” is a rare earth metal or a combination comprising at least one of the following metals yttrium, lanthanum, praseodymium, neodymium and combinations comprising at least one of these metals preferred.

In a farther embodiment an active soot oxidation catalyst comprising an ion exchanged solid solution can be employed as a coating, e.g., disposed on/in an inert substrate or carrier. Exhaust gas treatment devices can generally comprise housing or canister components that can be easily attached to an exhaust gas conduit and comprise a substrate for treating exhaust gases. The housing components can comprise an outer “shell”, which can be capped on either end with funnel-shaped “end-cones” or flat “end-plates”, which can comprise “snorkels” that allow for easy assembly to an exhaust conduit. Housing components can be fabricated of any materials capable of withstanding the temperatures, corrosion, and wear encountered during the operation of the exhaust gas treatment device, such as, but not limited to, ferrous metals or ferritic stainless steels (e.g., martensitic, ferritic, and austenitic stainless materials, and the like).

Disposed within the shell can be a retention material (“mat” or “matting”), which is capable of supporting a substrate, insulating the shell from the high operating temperatures of the substrate, providing substrate retention by applying compressive radial forces about it, and providing the substrate with impact protection. The matting is typically concentrically disposed around the substrate forming a substrate/mat sub-assembly.

Various materials can be employed for the matting and the insulation. These materials can exist in the form of a mat, fibres, preforms, or the like, and comprise materials such as, but not limited to, intumescent materials (e.g., a material that comprises vermiculite component, i.e., a component that expands upon the application of heat), non-intumescent materials, ceramic materials (e.g., ceramic fibers), organic binders, inorganic binders, and the like, as well as combinations comprising at least one of the foregoing materials. Non-intumescent materials include materials such as those sold under the trademarks “NEXTEL” and “INTERAM 1101HT” by the “3M” Company, Minneapolis, Minn., or those sold under the trademark, “FIBERFRAX” and “CC-MAX” by the Unifrax Co., Niagara Falls, N.Y., and the like. Intumescent materials include materials sold under the trademark “INTERAM” by the “3M” Company, Minneapolis, Minn., as well as those intumescent materials which are also sold under the aforementioned “FIBERFRAX” trademark.

Substrates or carriers can comprise any material designed for use in a spark ignition or diesel engine environment having the following characteristics: (1) capability of operating at temperatures up to about 600° C. and up to about 1,000° C. for some applications, depending upon the device's location within the exhaust system (e.g., manifold mounted, close coupled, or underfloor) and the type of system (e.g., gasoline or diesel); (2) capability of withstanding exposure to hydrocarbons, nitrogen oxides, carbon monoxide, particulate matter e.g. soot and the like, CO₂, and/or sulfur; and (3) have sufficient surface area and structural integrity to support a catalyst, if desired. These materials should be inert under the conditions imposed on them when in use. Some possible materials include cordierite, silicon carbide, metal, metal oxides e.g. alumina, and the like, glasses, and the like and mixtures comprising at least one of the foregoing materials. Some suitable inert ceramic materials include ‘Honey Ceram’, commercially available from NGK-Locke, Inc, Southfield, Mich., and ‘Celcor’, commercially available from Coming, Inc., Corning, N.Y. These materials can be in the form of foils, perform, mat, fibrous material, monoliths e.g. a honeycomb structure, and the like, other porous structures e.g., porous glasses, sponges, foams, pellets, particles, molecular sieves, and the like (depending upon the device), and combinations comprising at least one of the foregoing materials and forms, e.g., metallic foils, open pore alumina sponges, and porous ultra-low expansion glasses. Furthermore, these substrates can be coated with oxides and/or hexaaluminates, e.g. stainless steel foil coated with a hexa-aluminate scale.

Although the substrate can have any size or geometry, the size and geometry are preferably chosen to optimise surface area in the given exhaust gas emission control device design parameters. Typically, the substrate has a honeycomb geometry, with the combs through-channel having , any multi-sided or rounded shape, with substantially square, triangular, pentagonal, hexagonal, heptagonal, or octagonal or similar geometries preferred due to ease of manufacturing and increased surface area.

The exhaust gas treatment devices can be assembled utilizing various methods. Three such methods are the stuffing, clamshell, and tourniquet assembly methods. The stuffing method generally comprises pre-assembling the matting around the substrate and pushing, or stuffing, the assembly into the shell through a stuffing cone. The stuffing cone serves as an assembly tool that is capable of attaching to one end of the shell. Where attached, the shell and stuffing cone have the same cross-sectional geometry, and along the stuffing cone's length, the cross-sectional geometry gradually tapers to a larger cross-sectional geometry. Through this larger end, the substrate/mat sub-assembly can be advanced which compresses the matting around the substrate as the assembly advances through the stuffing cone's taper and is eventually pushed into the shell.

Exhaust gas treatment devices comprising the ion exchanged solid solutions can be employed in exhaust gas treatment systems to provide both an active soot combustion catalyst but also a NOx adsorption function, and thus specifically reduce a concentration of undesirable constituents in the exhaust gas stream. For example, as discussed above, an exemplary catalyst system can be formed utilising the ion exchanged OS as a catalyst, wherein the catalyst system is disposed on a substrate, which is then disposed within a housing. Disposing the substrate to an exhaust gas stream can then provide at least a NOx storage function, and desirably even reduce the concentration of at least one undesirable constituent contained therein.

According to one embodiment of the present invention, a CDPF or Diesel NOx Particulate Trap can comprise a porous substrate having alternating channels. The alternating channels comprise upstream channels and downstream channels, which both have an upstream end and a downstream end. The upstream channels are configured such that its upstream end is open and allows exhaust gas to flow through. The downstream end of the upstream channels is blocked, which does not allow exhaust gas to flow therethrough. The downstream channels are configured such that its upstream end is blocked, which does not allow exhaust gas to flow therethrough. The downstream end of the downstream channels is open, which allows exhaust gas to flow therethrough. In use, the exhaust gas flowing from the upstream channels passes through the walls of the substrate to the downstream channels. A solid solution can be dispersed within the upstream channels and downstream channels, and possibly within the substrate (e.g., depending upon the application method, porosity of the substrate, the size of the solid solution granules, and other variables).

### EXAMPLES

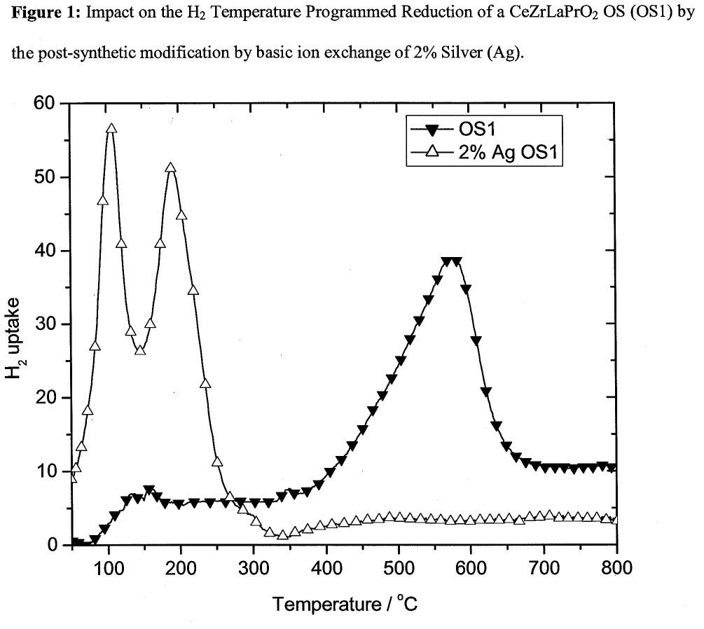

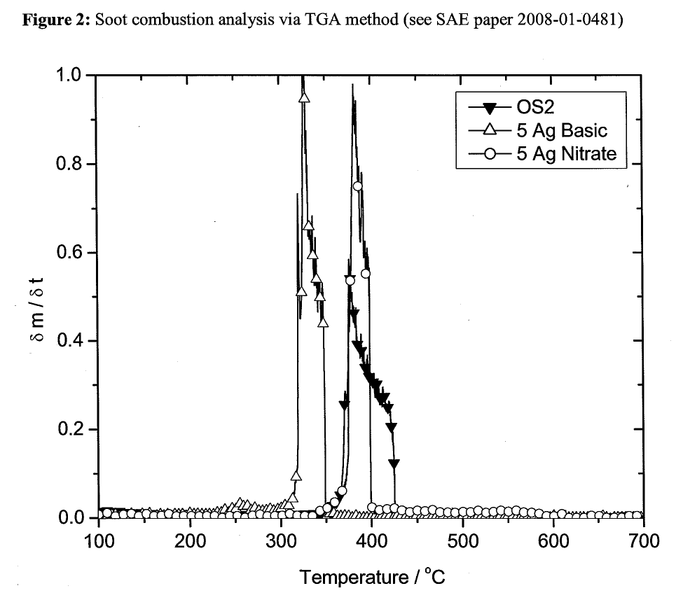

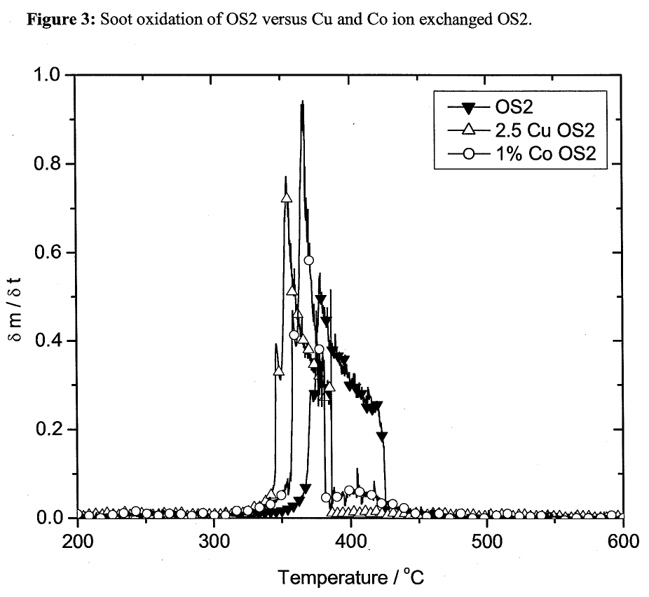

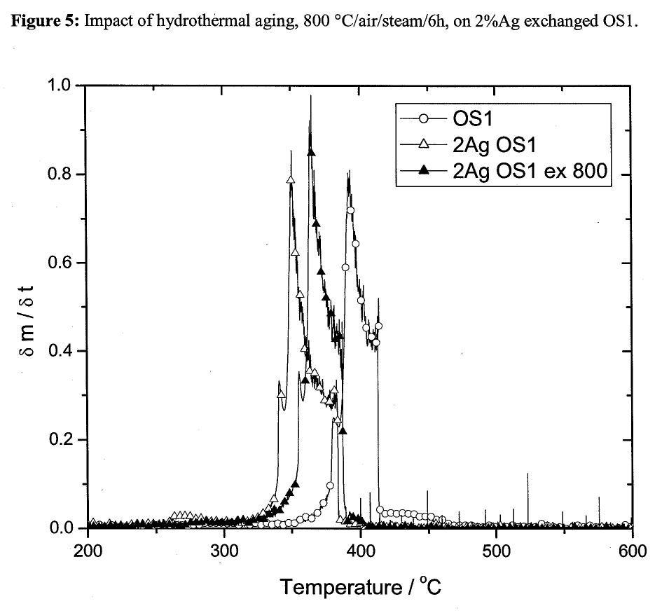

The theory and synthetic method(s) applied to achieve promotion of conventional Ce—Zr-based mixed oxides by the basic exchange method is described in detail in our copending application which is incorporated herein by reference DP315579A. The benefits obtained by the method are clearly evident in FIGS. 1-5 wherein redox performance, as determined by either H2 TPR or by TGA soot combustion studies, consistently show significant promotion. The promotion is observed for both a range of cationic dopants and a range of OS compositions, thereby illustrating the generic nature of the synergy observed. The data also confirm that the benefit arises as a result of the use of specific alkaline precursor types, with conventional metal nitrate addition resulting in no significant promotion (FIG. 2) and that promotion achieved possesses good hydrothermal durability thereby enabling its use in vehicular applications (FIG. 5).

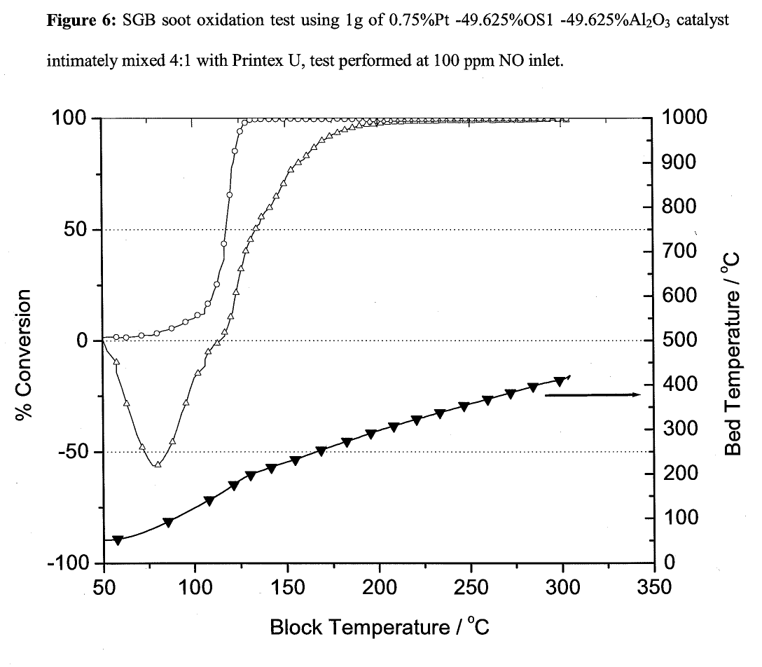

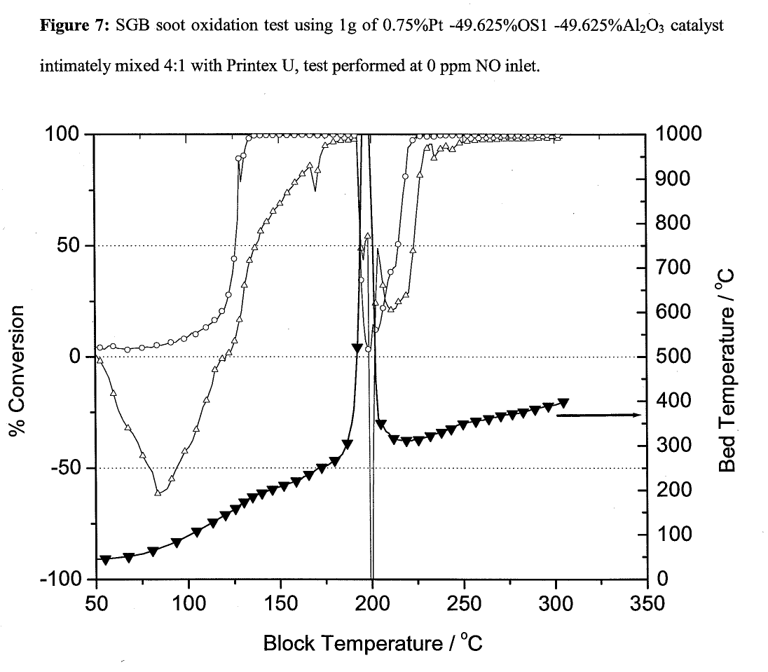

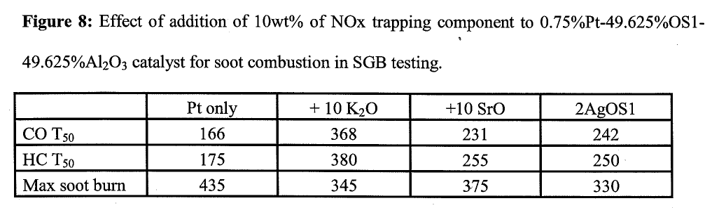

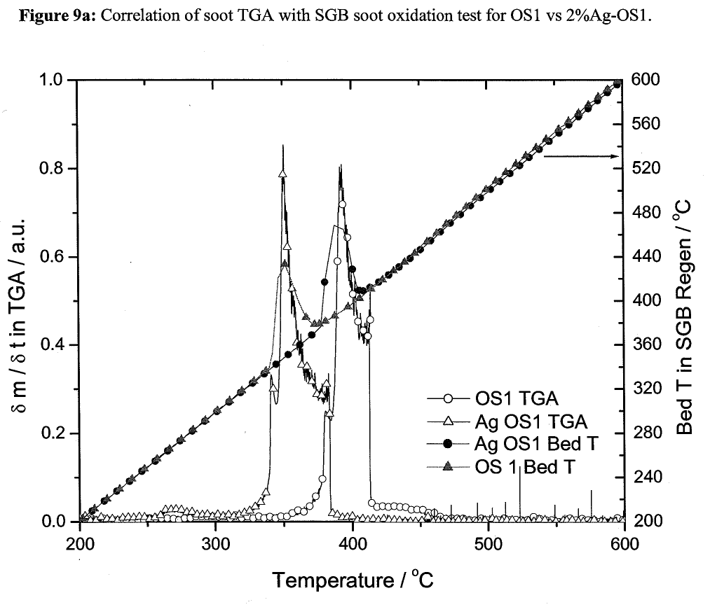

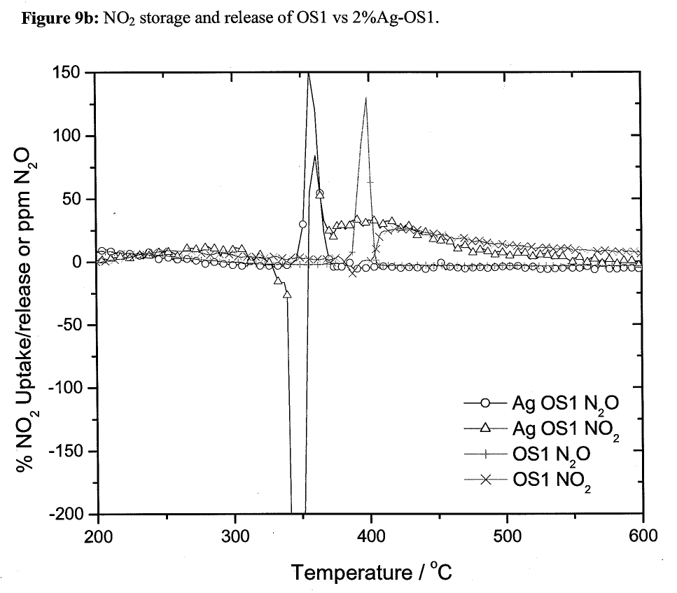

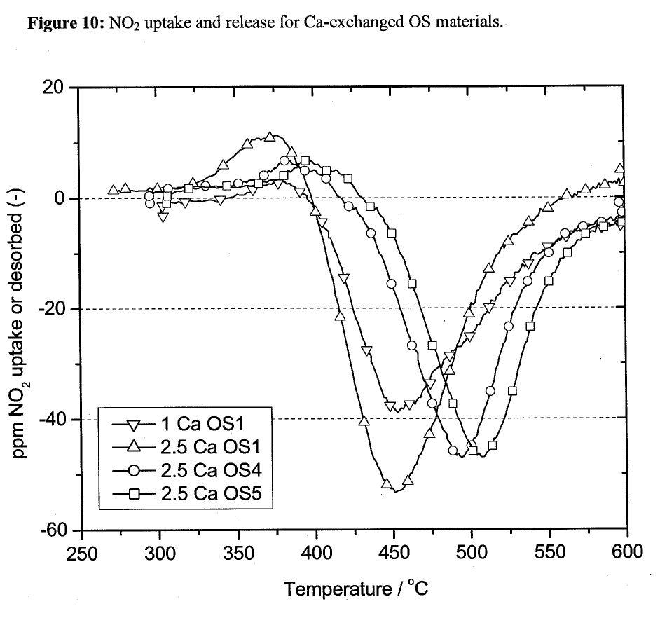

The data herein also illustrates a further benefit obtained with the ion-exchanged OS, specifically the introduction of dual functionality, in this case an additional NOx scavenging/adsorption function (FIGS. 6-10). The ability of the ion exchanged material to scavenge NOx is of particular importance as it disables the ‘de-coupling’ mechanism of NO2, which has been shown to destroy the intimate contact between catalyst and soot required for direct catalysed soot oxidation (see SAE paper 2008-01-0481). The impact of de-coupling is clearly demonstrated is FIGS. 6 and 7, in the case of NO in the reactive gas environment, low temperature soot oxidation is not realised but simply removing NO restores the ability of the OS to initiate soot oxidation. Similar benefits with respect to soot oxidation may be realised by addition of a conventional NOx trap (FIG. 8), but only at the expense of CO/HC emissions function and, as is shown in the data, such an approach is less efficient than the use of the dual function ion-exchanged OS (FIGS. 8-10).

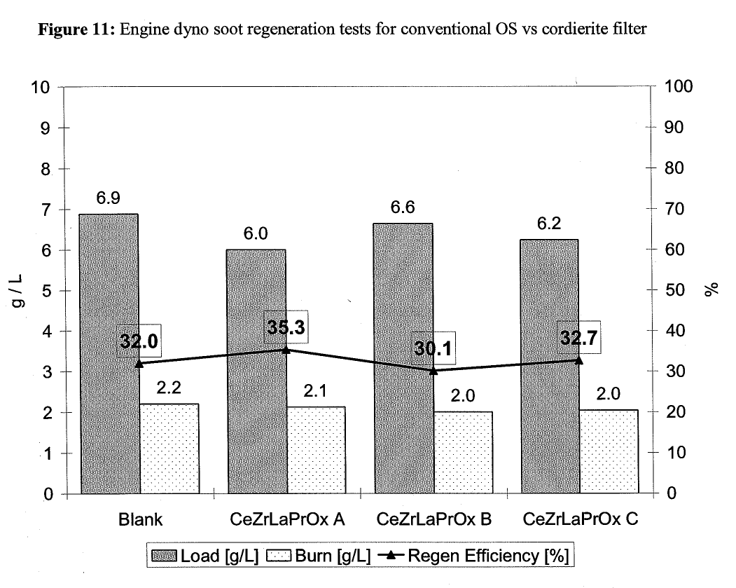

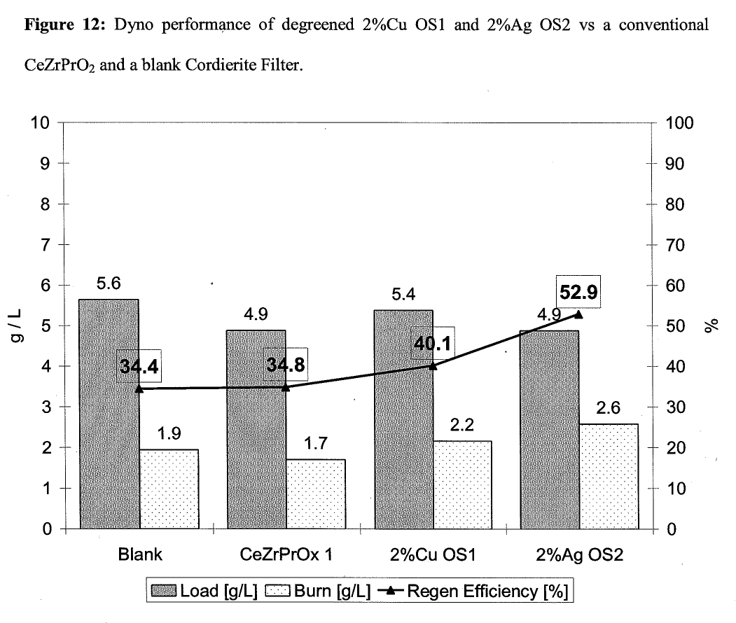

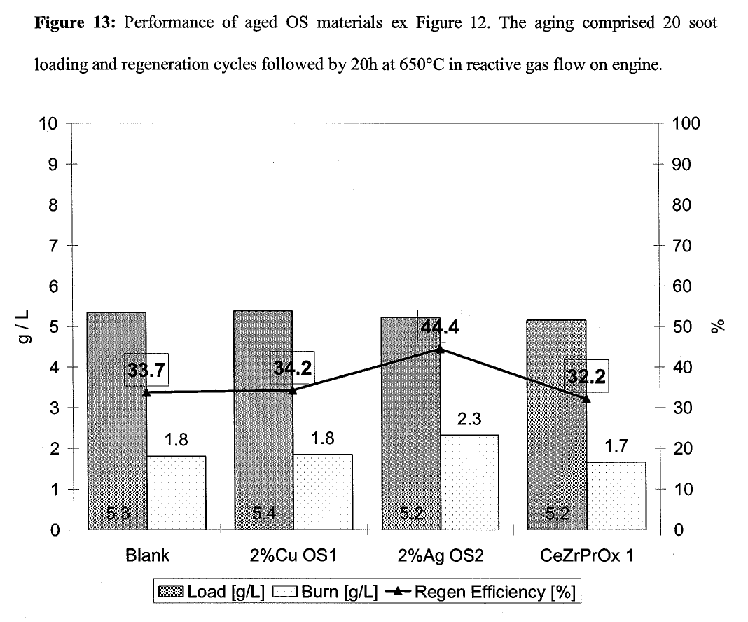

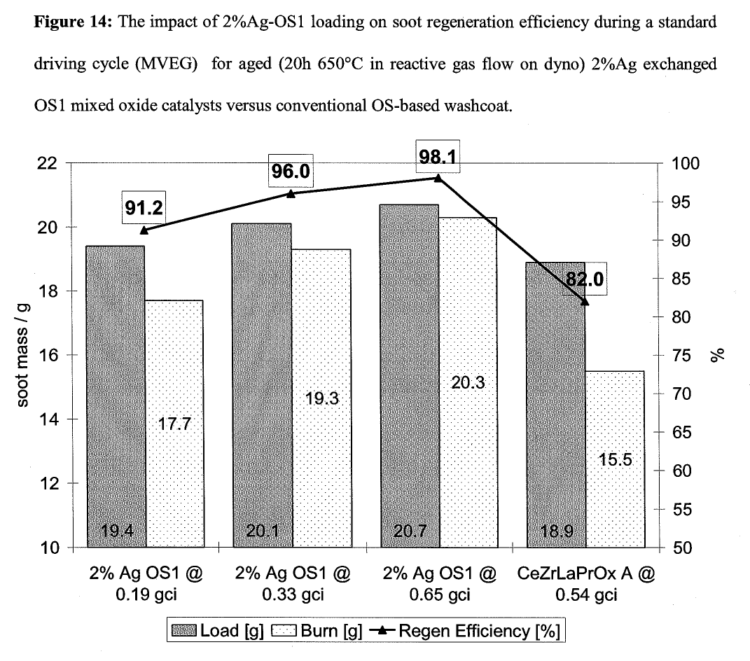

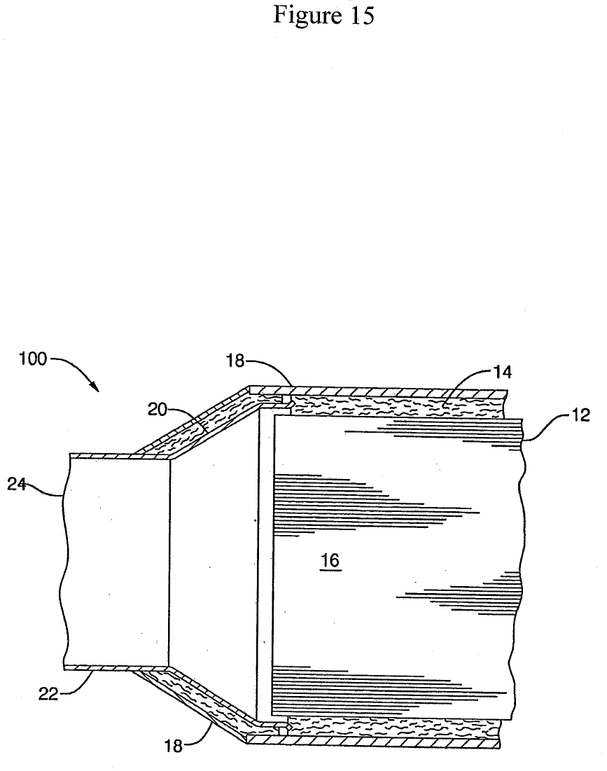

Most importantly the benefits of the ion exchanged OS are also realised under application conditions (FIGS. 11-14). Hence while conventional OS-based washcoats offer no performance benefits versus an uncoated cordierite filter for lower temperature regeneration, the use of 2% Cu OS1 and especially 2% Ag OS2 provide for enhanced activity. In the case of 2% Ag—OS2 these benefits are maintained after extensive aging, confirming its suitability for vehicular applications. These benefits are further highlighted in the vehicle testing summary shown in FIG. 14. Herein aged filters coated with 2% Ag exchanged OS1 mixed oxide offer 10-20% improved performance compared to a commercial OS-based washcoat coated filter at significantly lower regeneration temperatures cf. OEM calibration. Finally the observation of a benefit directly proportional to washcoat loading and hence increased interfacial catalyst-soot contact is consistent with the proposed direct catalytic soot oxidation mechanism.

Further variations and modifications of the herein described invention will be apparent to those skilled in the art form the foregoing and are encompassed by the claims appended hereto.

We claim:

1. A particulate filter device for the capture and catalytic oxidative regeneration of solid material produced as a byproduct of an internal combustion engine comprising: a particulate filter comprising a substrate having a redox active material disposed thereon, wherein the redox active material is a base metal doped mixed oxide/solid solution produced by contacting of redox active material with a precursor solution of dissolved cations under conditions of high pH/low Hydronium Ion (H₃O⁺)/low proton (H⁺) content; and a housing disposed around the substrate.

2. The particulate filter device of claim 1, wherein the particulate filter is a wall flow type filter.

3. The base metal doped mixed oxide/solid solution of claim 1, wherein the oxide support is a refractory oxide.

4. The base metal doped mixed oxide/solid solution of claim 1, wherein the refractory/mixed oxide contains Cerium oxide.

5. The base metal doped mixed oxide/solid solution of claim 1, wherein the Cerium oxide is a solid solution of Cerium and Zirconium Oxide (Ce—Zr Oxide).

6. The base metal doped mixed oxide/solid solution of claim 1, wherein the Ce—Zr oxide is substantially phase pure solid solution with oxygen ion conducting properties and comprises
a. up to about 95% Zirconium
b. up to about 95% Cerium
c. up to about 20% of a stabiliser selected from the group consisting of rare earths, yttrium and mixtures thereof.

7. The base metal doped mixed oxide/solid solution of claim 1, wherein the base metal doped mixed oxide/solid solution contains one or more dopant base metal species selected from the group consisting of a transition metal, an alkali metal, an alkaline earth metal, group IIIb metal and mixtures thereof.

8. The base metal doped mixed oxide/solid solution of claim 1, wherein the base metal is introduced into the redox active material by an ammonium hydroxide/ammoniacal complex of the metal cations.

9. The base metal doped mixed oxide/solid solution of claim 1, wherein the base metal is introduced into the redox active material by an organic amine complex of the metal cations.

10. The base metal doped mixed oxide/solid solution of claim 1, wherein the base metal is introduced into the redox active material by a hydroxide compound of the metal cations.

11. The base metal doped mixed oxide/solid solution of claim 1, wherein the concentration of metal species introduced is about 0.01 weight % to about 10 weight %.

12. The base metal doped mixed oxide/solid solution of claim 1, wherein the concentration of metal species introduced is 0.1 wt % to about 2.5 wt %

13. The base metal doped mixed oxide/solid solution of claim 1, wherein the resultant product contains metal at high levels of dispersion such that phase analysis by conventional X-Ray diffraction methods retains a substantially phase pure Cubic Fluorite phase (>95%), with bulk metal oxide dopant phase being recorded at <5% and dopant metal oxide particle size, as determined by line-broadening/Scherrer equation method, is about 30 Å to about 100 Å.

14. The base metal doped mixed oxide/solid solution of claim 1, wherein the resultant product contains metal at high levels of dispersion such that phase analysis by XRD reveals the promoted material maintains at least 95% Cubic Fluorite phase after hydrothermal oxidising aging at 1100° C.

15. A particulate filter device of claim 1, wherein the temperature of ‘regeneration’ is about 250 to about 650° C.

16. A particulate filter device of claim 1, wherein the temperature of ‘regeneration’ is about 350 to about 550° C.

17. A particulate filter device of claim 1, wherein the particulate filter does not comprise a platinum group metal.

18. A particulate filter device of claim 1, wherein the particulate filter does additionally comprise a platinum group metal.

19. A particulate filter device of claim 1, wherein the platinum group metal is selected from the group comprising platinum, palladium, rhodium and mixtures thereof.

23. A method of treating exhaust gas comprising passing an exhaust gas over the catalyst of claim 1.
